(19) United States
(12) Patent Application Publication
(10) Pub. No.: US 2019/0070988 A1
(43) Pub. Date: Mar. 7, 2019

(54) VEHICLE SEAT FOR PREVENTING FORMATION OF WRINKLES AND METHOD OF MANUFACTURING THE SAME

(71) Applicant: S&B CO.,LTD., Gyeongju-si (KR)

(72) Inventors: Jae Keun SUNG, Ulsan (KR); Jong Hee PARK, Gyeongju-si (KR); Chong Hoon LEE, Ulsan (KR); Jin Bae CHO, Incheon (KR); Man Ho LEE, Hwaseong-si (KR); Chung Ho LIM, Osan-si (KR)

(73) Assignee: S&B CO.,LTD., Gyeongju-si (KR)

(21) Appl. No.: 15/704,508

(22) Filed: Sep. 14, 2017

(30) Foreign Application Priority Data
Sep. 7, 2017 (KR) 10-2017-0114564

(51) Int. Cl. B60N 2/58; B60N 2/64; B60N 2/70; B32B 5/18; B32B 37/14; B32B 5/24

(52) U.S. Cl. CPC B60N 2/5875; B60N 2/64; B60N 2/7017; B32B 5/18; B32B 2307/3065; B32B 5/245; B32B 2605/003; B32B 2305/022; B32B 37/14

(57) ABSTRACT

Provided are a vehicle seat for preventing formation of wrinkles and a method of manufacturing the same, and more particularly, a vehicle seat for preventing formation of wrinkles, whereby a backing cloth between a first foam layer and a second foam layer is bonded using a double flame lamination method so that the first foam layer is freely moved and simultaneously wrinkles can be prevented from being formed on a surface of the vehicle seat, and a method of manufacturing the same.

### CROSS-REFERENCE TO RELATED APPLICATION

This application claims priority to and the benefit of Korean Patent Application No. 10-2017-0114564, filed on Sep. 7, 2017, the disclosure of which is incorporated herein by reference in its entirety.

### BACKGROUND

### 1. Field of the Invention

The present invention relates to a vehicle seat for preventing wrinkles from being formed on a surface of the vehicle seat.

### 2. Discussion of Related Art

Generally, a vehicle seat includes a cushion portion A on which a person sits, and a back portion B against which the person leans, as illustrated in FIG. 1. A cushion bolster portion C and a back bolster portion D can be formed at both sides of the cushion portion A and the back portion B.

The vehicle seat includes a frame, the cushion portion A that covers the frame, and a surface portion that surrounds and finishes the cushion portion A.

A vehicle seat according to the related art is generally manufactured by sewing the surface portion formed of a leather fabric onto the cushion portion A formed of an urethane sponge. However, due to a lifting phenomenon of an unsewed intermediate portion, the vehicle seat is pushed by a passenger's load and thus wrinkles are formed on the vehicle seat. In order to solve this problem, prior arts for preventing wrinkles from being formed on the surface of the vehicle seat have been developed.

Korean Patent Registration No. 1353506 suggests a method, whereby an artificial cotton wool layer is attached to a back surface of a leather fabric so that bending or fine wrinkles does not occur in a vehicle seat due to characteristics of non-repulsive force or non-elasticity of an artificial cotton wool. However, because the cotton wool comes out from a ventilation seat having air permeability, it is difficult to apply the method to the ventilation seat, and there are inconveniences in manufacturing the artificial cotton wool layer.

According to Korean Patent Registration No. 0278555, a top surface of a sponge is molten, and a leather fabric is coated on the top surface of the molten sponge and is compressed and then the pressurized leather fabric and the sponge are fixed to a seat frame for a vehicle. Thus, a method for preventing wrinkles from being formed on the leather fabric while no lifting phenomenon occurs between the leather fabric and the sponge, has been suggested. However, even in this case, a problem in which a leather material comes up and wrinkles are formed due to the passenger's load during a long-term use, has not been solved. Thus, there are inconveniences that a seat cover needs to be replaced with another one during a long-term use.

Recently, a seat having a surface with many curves instead of a flat seat has been mainly used so as to increase external luxury of a vehicle seat and comfortableness during sitting. Thus, a technology in which no lifting or wrinkles of a surface occurs even in the case where the seat is applied to a curved surface, is required.

### PRIOR-ART DOCUMENT

### Patent Document

Korean Patent Registration No. 1353506 (published on Jan. 23, 2014)

Korean Patent Registration No. 0278555 (published on Jan. 15, 2001)

### SUMMARY OF THE INVENTION

The present invention is directed to a vehicle seat for preventing wrinkles from being formed on a surface of the vehicle seat as a passenger gets into or out of a vehicle by inserting a backing cloth between foam layers.

The present invention is also directed to a vehicle seat, whereby no lifting or wrinkles occurs in a surface of the vehicle seat even when the vehicle seat is applied to a curved surface.

The present invention is also directed to a vehicle seat, whereby riding comfort is improved when a passenger sits on the vehicle seat.

Technical objectives of the present invention are not limited to the above-mentioned exemplary technical objectives, and other unmentioned technical objectives will be clearly understood by those skilled in the art from the following description.

According to an aspect of the present invention, there is provided a vehicle seat for preventing formation of wrinkles, including: a first foam layer and a second foam layer, which are disposed at a lower side of a fabric layer applied onto a surface of the vehicle seat; and a backing cloth bonded between the first foam layer and the second foam layer.

According to another aspect of the present invention, there is provided a vehicle seat for preventing formation of wrinkles, including: a first foam layer, a second foam layer, and a backing cloth, which are bonded to one another through double flame lamination, and foam thicknesses and densities of the first foam layer and the second foam layer may be diverse.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view of names of portions of a vehicle seat according to the related art;

FIG. 2 is a perspective view of a vehicle seat according to an embodiment of the present invention;

FIG. 3 is an exploded perspective view of the vehicle seat according to an embodiment of the present invention;

FIG. 4 is a test report of test results of a polyurethane foam that is actually applied to a first foam layer and a second foam layer, according to an embodiment of the present invention;

FIG. 5 is a table showing test results of density, tensile strength, and tensile ductility of each denier of a backing cloth according to an embodiment of the present invention;

FIG. 6 is a view of a method of manufacturing a vehicle seat for preventing formation of wrinkles, according to an embodiment of the present invention;

FIG. 7 is a photo of a cross-section of a vehicle seat according to an embodiment of the present invention;

FIG. 8 is a photo of an internal structure of the vehicle seat according to an embodiment of the present invention;

FIG. 9 is a photo of a vehicle seat according to the related art;

FIG. 10 is a photo of a vehicle seat for preventing formation of wrinkles according to an embodiment of the present invention;

FIG. 11 is a view of a lamination method according to an embodiment of the present invention;

FIG. 12 is a view of a first correction unit while the lamination method is used, according to an embodiment of the present invention;

FIG. 13 is a view of a state before a second correction unit operates while the lamination method is used, according to an embodiment of the present invention; and

FIG. 14 is a view of a state after the second correction unit operates while the lamination method is used, according to an embodiment of the present invention.

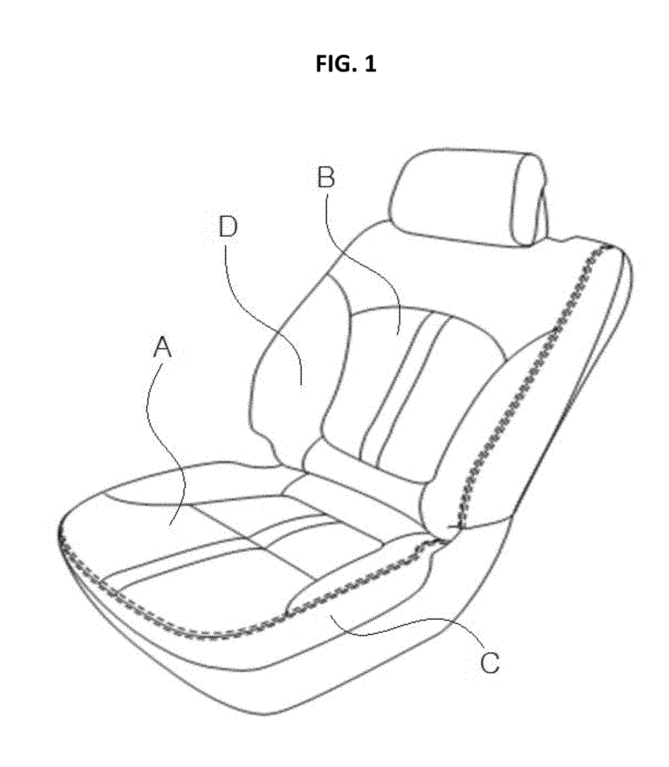

### DETAILED DESCRIPTION OF EXEMPLARY EMBODIMENTS

Hereinafter, exemplary embodiments of the present invention will be described in detail below with reference to the accompanying drawings. However, these embodiments are just examples so that those skilled in the art can easily embody the present invention, and the present invention can be implemented in several different forms. Thus, the scope of the invention is not interpreted by being limited to the following embodiments.

Objectives and effects of the present invention can be naturally understood or more apparent by the following descriptions and are not limited by only the following descriptions.

Objectives, features and advantages of the present invention will be more apparent through the following detailed descriptions. Also, in the description of the invention, if it is determined that a detailed description of commonly-used technologies or structures related to the invention may unnecessarily obscure the subject matter of the invention, the detailed description will be omitted.

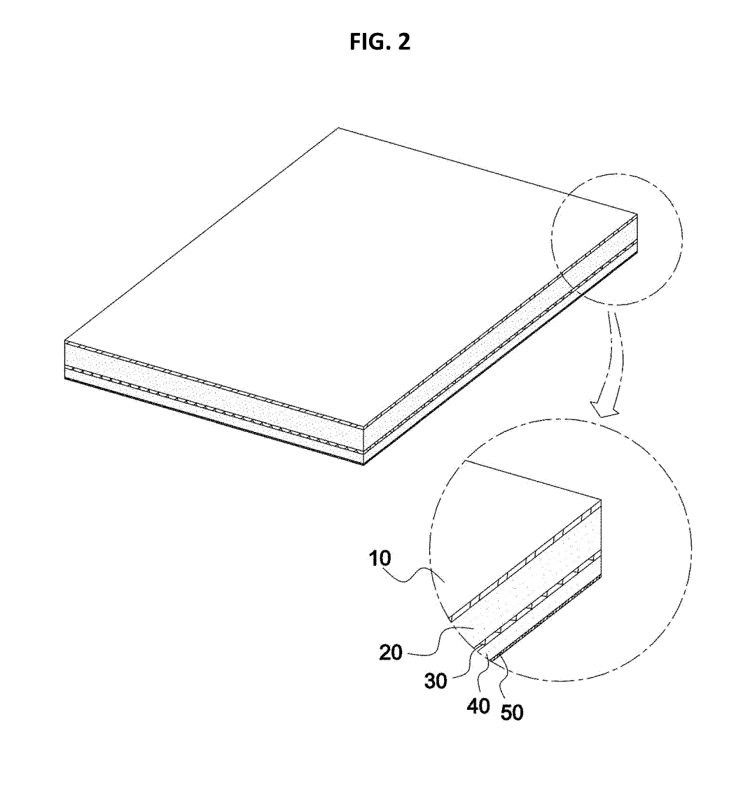

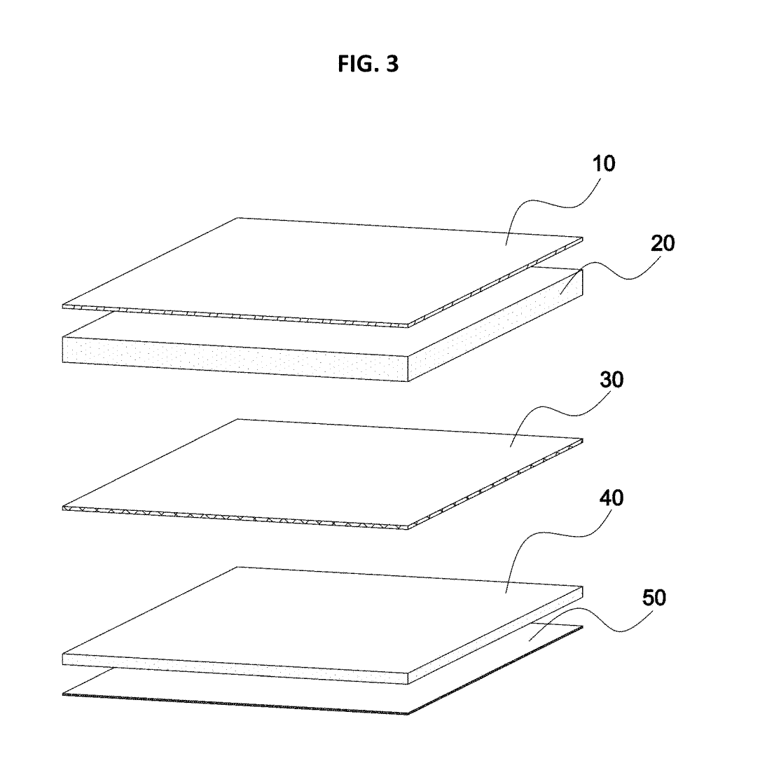

FIG. 2 is a perspective view of a vehicle seat according to an embodiment of the present invention, and FIG. 3 is an exploded perspective view of elements of the vehicle seat according to an embodiment of the present invention.

The vehicle seat according to the present invention is applied to a cushion portion A corresponding to a hip plate of a vehicle, a back portion B corresponding to a back plate, and a cushion bolster portion C and a back bolster portion D formed as curved surfaces at both sides of the cushion portion A and the back portion B.

Referring to FIGS. 2 and 3, the vehicle seat according to the present invention includes a fabric layer 10, a first foam layer 20, a second foam layer 40, a backing cloth (B/CLOTH) 30, and an SD coating layer 50.

The fabric layer 10 may be disposed at a top end of the vehicle seat and may be formed of one material from among fabric, artificial leather, and natural leather.

The first foam layer 20 is adhered to a bottom surface of the fabric layer 10, and the second foam layer 40 is disposed at a bottom end of the first foam layer 20. The first foam layer 20 and the second foam layer 40 may be formed of a material of polyurethane foam or polyester foam. The first foam layer 20 and the second foam layer 40 may have a thickness of 2 to 10 mm, and thicknesses of foam layers may be different from each other according to an applied portion of the vehicle seat.

According to an embodiment, preferably, the cushion portion and the back portion include the first foam layer 20 having a thickness of 5 to 10 mm and the second foam layer 40 having a thickness of 3 to 5 mm. Also, preferably, the cushion bolster portion and the back bolster portion include the first foam layer 20 having a thickness of 3 to 5 mm and the second foam layer 40 having a thickness of 2 to 3 mm. This is a most preferable embodiment when curvatures according to each applied portion of the vehicle seat and the weight of a supported person are considered.

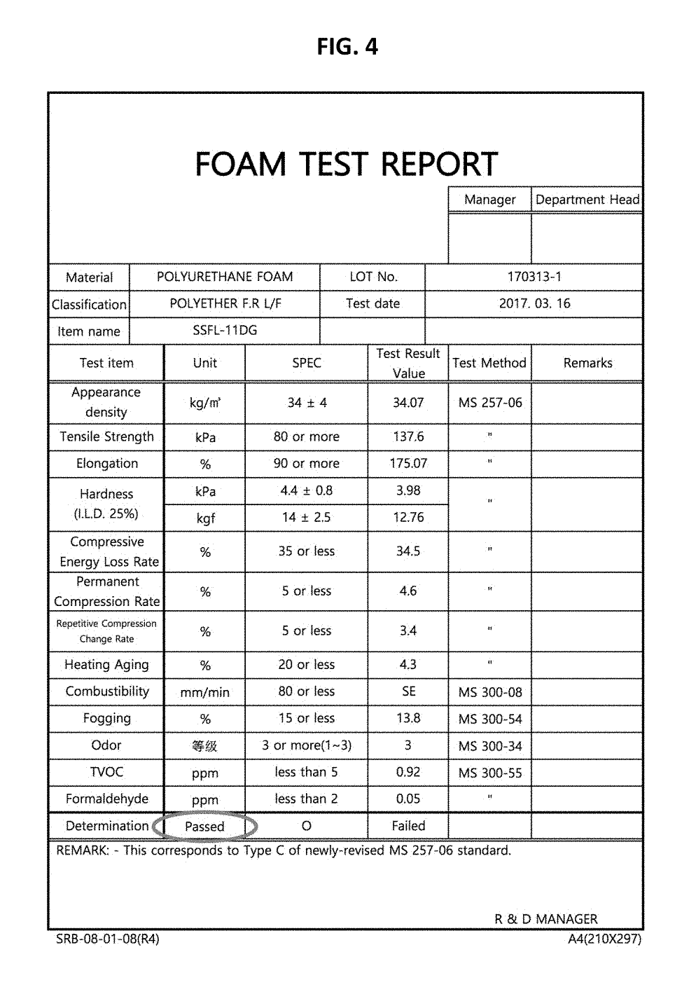

FIG. 4 is a test report of test results of a polyurethane foam that is actually applied to the first foam layer 20 and the second foam layer 40 according to an embodiment of the present invention.

According to the above FOAM test, it was confirmed whether an appearance density, a tensile strength, elongation, hardness, a compressive energy loss rate, a permanent compression rate, a repetitive compression change rate, and heating aging of the polyurethane foam satisfied the criterion using a newly-revised MS 257-06 standard. Also, it was confirmed whether combustibility satisfied the criterion using an MS 300-08 standard, and it was confirmed whether fogging satisfied the criterion using an MS 300-54 standard. Also, it was confirmed whether an odor satisfied the criterion using an MS 300-34 standard, and it was confirmed whether TVOC and formaldehyde satisfied the criterion using an MS 300-55 standard.

According to the results of the test, it was confirmed that all items satisfied a test criterion.

The polyurethane foam applied to the vehicle seat according to the present invention needs to satisfy MS conditions, and preferably a unit for density is kg/m³, and a unit for thickness is mm, and hardness of foam of the cushion portion A and the back portion B is equal to or less than 15 kgf so as to improve a passenger's long-term drive and riding comfort, and it is effective that hardness of a foam of the bolster portions C and D is 15 to 18 kgf.

According to an embodiment, in order to manufacture a vehicle seat that requires ventilation, it is preferable that the cushion portion A and the back portion B use a filter foam having air permeability and the density of the foam is 32±3 kg/m³, and it is effective that the thickness of the first foam layer 20 is 5 to 10 mm, and the thickness of the second foam layer 40 is 2 to 5 mm, and the backing cloth (B/CLOTH) 30 between the first foam layer 20 and the second foam layer 40 needs to use fabric having air permeability.

Also, in a vehicle seat that does not require ventilation according to another embodiment of the present invention, a foam having a density of 26 to 50 kg/m³ may be used in the cushion portion A and the back portion B, and preferably, the thickness of the first foam layer 20 is 5 to 10 mm, and preferably, the thickness of the second foam layer 40 is 2 to 5 mm, and in particular, it is effective that a density of the second foam layer 40 is 26 to 18 kg/m³.

It is effective that the density of the first foam layer 20 of the bolster portions C and D is 26 to 50 kg/m³ so as to increase volume of the seat, and the thickness thereof is 3 to 5 mm, and hardness of the foam is 15 to 18 kgf. Preferably, the density of the second foam layer 40 is 26 to 18 kg/m³, and hardness thereof is equal to or less than 15 kgf, and the thickness thereof is 2 to 3 mm.

The backing cloth (B/CLOTH) 30 is bonded between a bottom surface of the first foam layer 20 and a top surface of the second foam layer 40. The backing cloth (B/CLOTH) 30 is used to disperse a load applied between the first foam layer 20 and the second foam layer 40. Thus, the first foam layer 20 and the second foam layer 40 may be moved in different directions, and even when the second foam layer 40 is fixed to a mold pad for the vehicle seat, the first foam layer 20 is freely moved so that a restoring force with respect to remaining wrinkles and curved wrinkles of the vehicle seat formed caused by getting on/off can be improved. The backing cloth (B/CLOTH) 30 may be formed of one fiber from among a 15 denier fiber, a 20 denier fiber, a 20 denier (zeroelongation) fiber, a 50 denier fiber, and a 150 denier fiber. The zeroelongation means that there is no elongation in a direction in which a fiber comes untied.

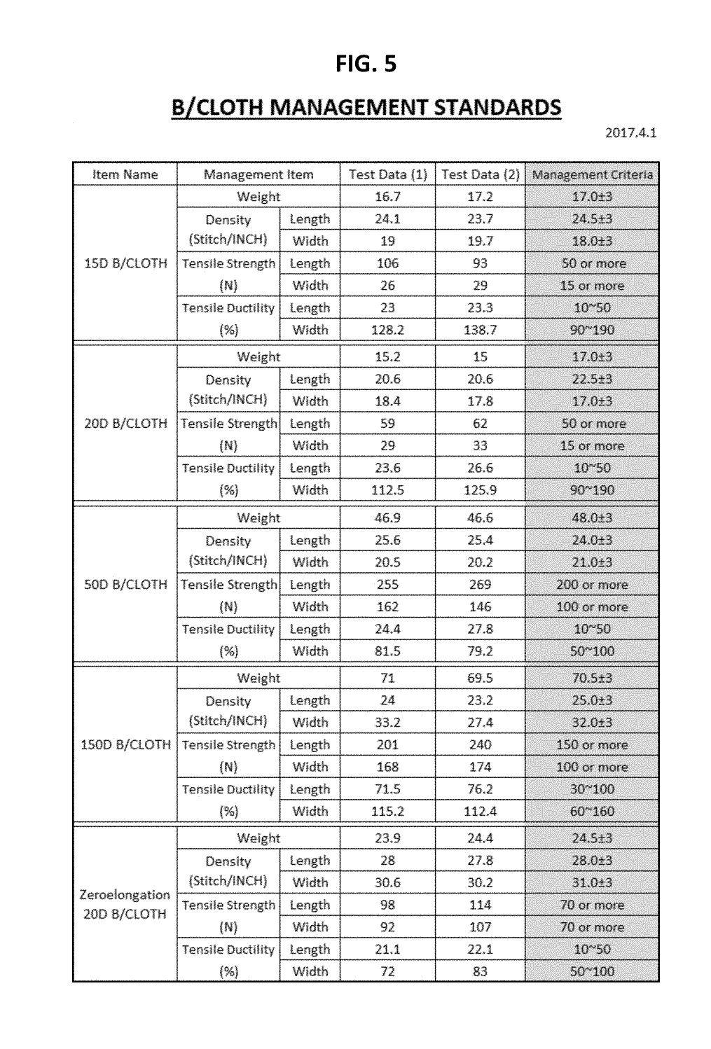

FIG. 5 is a table showing test results of density, tensile strength, and tensile ductility of each denier of the backing cloth (B/CLOTH) 30 according to an embodiment of the present invention.

Referring to FIG. 5, the results of a test of the backing cloth (B/CLOTH) 30 according to each denier used herein are appropriate for all management criteria.

The backing cloth (B/CLOTH) 30 described above is a material widely used in a method of manufacturing a vehicle seat according to the related art.

In the cushion portion A and the back portion B to which a most load of a force is applied, when the passenger sits on the vehicle seat, elongation caused by the load of the passenger on the fabric layer 10 is minimized using the backing cloth (B/CLOTH) 30 having small tensile ductility in a lengthwise or widthwise direction so that the effects of preventing formation of wrinkles for the seat can be attained. Thus, it is effective to use the backing cloth (B/CLOTH) 30 of the cushion portion A and the back portion B having lengthwise tensile ductility of 22 to 28% or less and widthwise ductility of 74 to 82% or less of a 50 denier fiber, or lengthwise tensile ductility of 21 to 23% or less and widthwise tensile ductility of 72 to 83% or less of a 20 denier (zeroelongation) fiber. It is effective to use a material having widthwise high tensile ductility (%) for a cushion bolster portion C, a back bolster portion D, and a back top end portion. The bolster portions C and D have a good volume in a seat finished product, and bending wrinkles may be formed when widthwise tensile ductility of the back top end portion is low. Thus, a 15 denier or 20 denier fiber having tensile ductility (%) of the attached backing cloth (B/CLOTH) 30 may be used for the seat bolster portions C and D and the back top end portion.

Also, preferably, the backing cloth (B/CLOTH) 30 is formed of a fabric material having flame retardance for a flame lamination construction method that will be described later. Also, preferably, the first foam layer 20 and the second foam layer 40 bonded to upper and lower portions of the backing cloth (B/CLOTH) 30 are formed of a filter foam when being applied to a ventilation seat.

The backing cloth (B/CLOTH) 30, the first foam layer 20, and the second foam layer 40 may also be bonded to one another using a web bond dry lamination method but are preferably bonded using a bond dry lamination or flame lamination method. In this case, a double flame lamination method including flame lamination bonding of the first foam layer 20 and the backing cloth (B/CLOTH) 30 and flame lamination bonding of the second foam layer 40 and the backing cloth (B/CLOTH) 30 may be used.

The SD coating layer 50 is applied onto a bottom surface of the second foam layer 40 for slip property during seat sewing and slip characteristics during a seat finished product work. The SD coating layer 50 disclosed in Korean Patent Registration No. 10-1549368 (registered on Aug. 26, 2015) by the same applicant is applied.

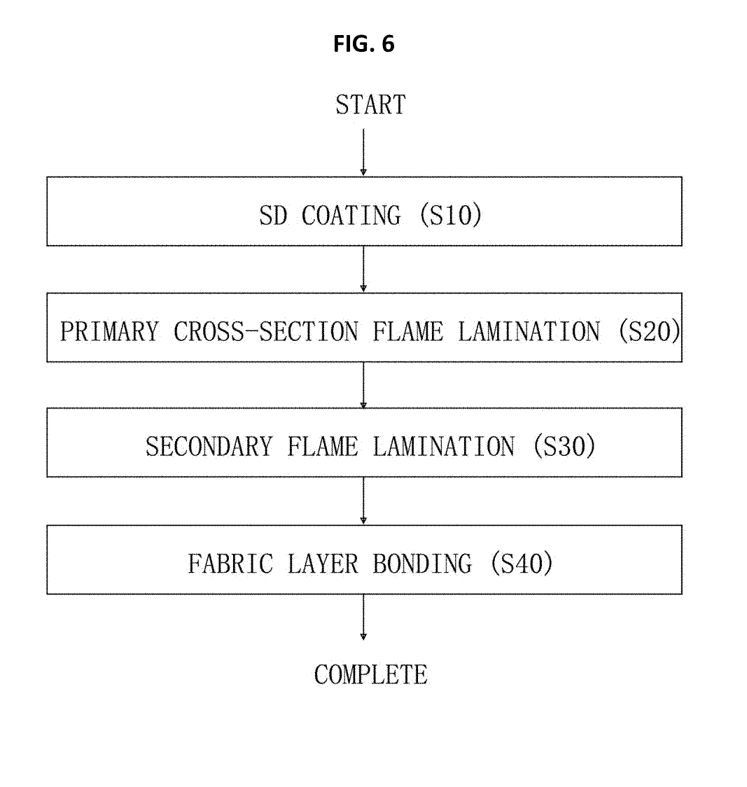

Hereinafter, a method of manufacturing a vehicle seat for preventing formation of wrinkles according to an embodiment of the present invention will be described with reference to FIG. 6.

Referring to FIG. 6, the vehicle seat according to the present invention is manufactured in the order of SD coating (S10), primary cross-section flame lamination (S20), secondary flame lamination (S30), and fabric layer bonding (S40).

SD coating (S10) is an operation of performing SD coating on the bottom surface of the second foam layer 40. Through SD coating, the second foam layer 40 can be prevented from being worn out or damaged.

In SD coating (S10), a polyurethane (PU) water resin solvent is uniformly coated on the bottom surface of the second foam layer 40 using a mesh roller coating method.

Primary cross-section flame lamination (S20) is an operation of bonding the second foam layer 40 and the backing cloth (B/CLOTH) 30 using a flame lamination method.

According to an embodiment, when a thickness of a foam that bonds the second foam layer 40 to the backing cloth (B/CLOTH) 30 is 3 mm, preferably, flame lamination is performed in a state in which a roller gap is 2.0 to 2.5 mm, a gas pressure is 20 to 22 kgf/cm², an air pressure is 4.5 to 4.7 kgf/cm², a speed (gauge) of a sponge is 70 to 73 m/min, a distance between burners is 3 mm and a lamination speed is 34 m/min

According to another embodiment, when the thickness of a foam that bonds the second foam layer 40 to the backing cloth (B/CLOTH) 30 is 5 mm, preferably, flame lamination is performed in a state in which a roller gap is 4.0 to 4.5 mm, a gas pressure is 20 to 22 kgf/cm², an air pressure is 4.5 to 4.7 kgf/cm², a speed (gauge) of a sponge is 65 to 70 m/min, a distance between burners is 4 mm and a lamination speed is 30 m/min.

In this case, the backing cloth (B/CLOTH) 30 may be bonded using one fiber from among a 15 denier fiber, a 20 denier fiber, a 20 denier (zeroelongation) fiber, a 50 denier fiber, and a 150 denier fiber.

When bonding of the second foam layer 40 and the backing cloth (B/CLOTH) 30 is completed according to primary cross-section flame lamination (S20), in secondary lamination (S30), the first foam layer 20 is bonded to a back surface of the backing cloth (B/CLOTH) 30.

According to an embodiment, in primary cross-section flame lamination (S20), when the thickness of a foam bonded to the backing cloth (B/CLOTH) 30 is 3 mm and the thickness of the first foam layer 20 to be bonded to the backing cloth (B/CLOTH) 30 is 5 mm, preferably, flame lamination is performed in a state in which a roller gap is 7 to 7.5 mm, a gas pressure is 20 to 22 kgf/cm², an air pressure is 4.0 to 4.5 kgf/cm², a speed (gauge) of a sponge is 70 to 80 m/min, a distance between burners is 5 mm and a lamination speed is 30 m/min.

According to another embodiment, in primary cross-section flame lamination (S20), when the thickness of a foam bonded to the backing cloth (B/CLOTH) 30 is 3 mm and the thickness of the first foam layer 20 to be bonded thereto is 7 mm, preferably, flame lamination is performed in a state in which a roller gap is 8.5 to 9 mm, a gas pressure is 20 to 23 kgf/cm², an air pressure is 4.0 to 4.5 kgf/cm², a speed (gauge) of a sponge is 50 to 60 m/min, a distance between burners is 8 mm and a lamination speed is 30 m/min.

Through the double flame lamination method that includes primary cross-section flame lamination (S20) and secondary flame lamination (S30) described above, the first foam layer 20, the second foam layer 40, and the backing cloth (B/CLOTH) 30 disposed therebetween are bonded to one another.

Subsequently, in fabric layer bonding (S40), the fabric layer 10 is bonded to the top surface of the bonded first foam layer 20. Also, the fabric layer 10 may be formed of one material from among fabric, artificial leather, and natural leather.

Also, the vehicle seat according to the present invention may be manufactured by changing upper and lower positions of the first foam layer 20 and the second foam layer 40 according to the thickness and density of a foam of each of the cushion portion, the back portion, and the bolster portion.

When the vehicle seat according to the present invention is manufactured according to the double flame lamination method, buffing wrinkles of the cushion portion can be prevented from being formed. Also, even when a seat to be applied to the bolster portion is manufactured by the double flame lamination method, working conditions of primary cross-section flame lamination (S20) and secondary flame lamination (S30) may be properly set so that the first foam layer 20 and the second foam layer 40 having various thicknesses and densities can be bonded to each other.

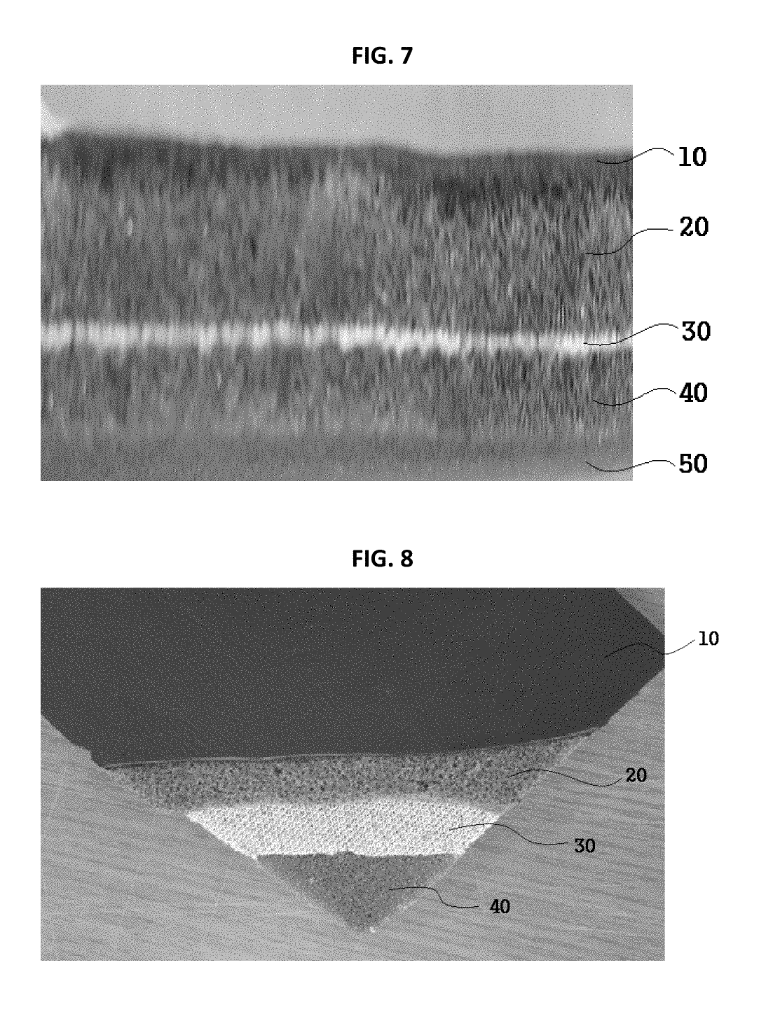

FIGS. 7 and 8 are photos showing an example of a vehicle seat according to the present invention.

FIG. 7 is a photo of a cross-section of a vehicle seat according to an embodiment of the present invention, and FIG. 8 is a photo of an internal structure of the vehicle seat according to an embodiment of the present invention.

Referring to FIGS. 7 and 8, the first foam layer 20 and the second foam layer 40 are bonded to a bottom end of the fabric layer 10 in a state in which the backing cloth (B/CLOTH) 30 is disposed therebetween.

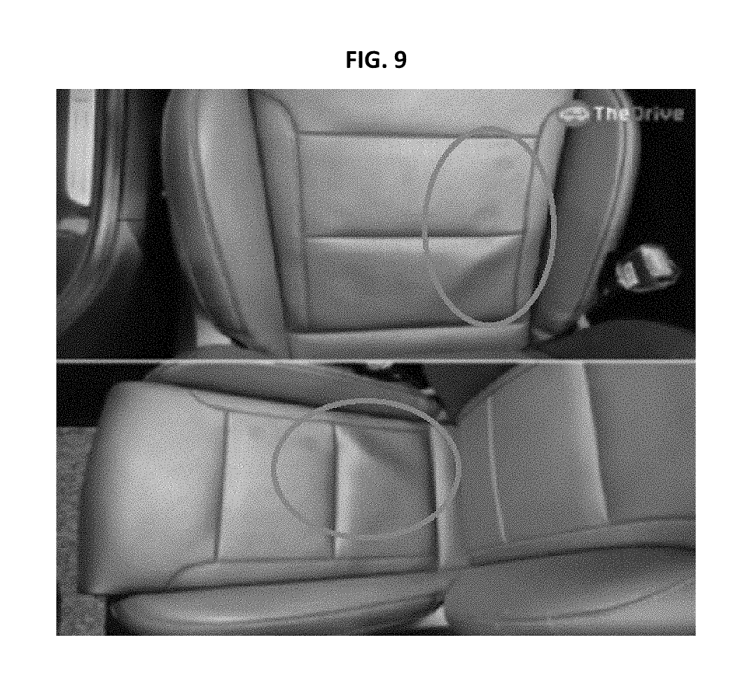

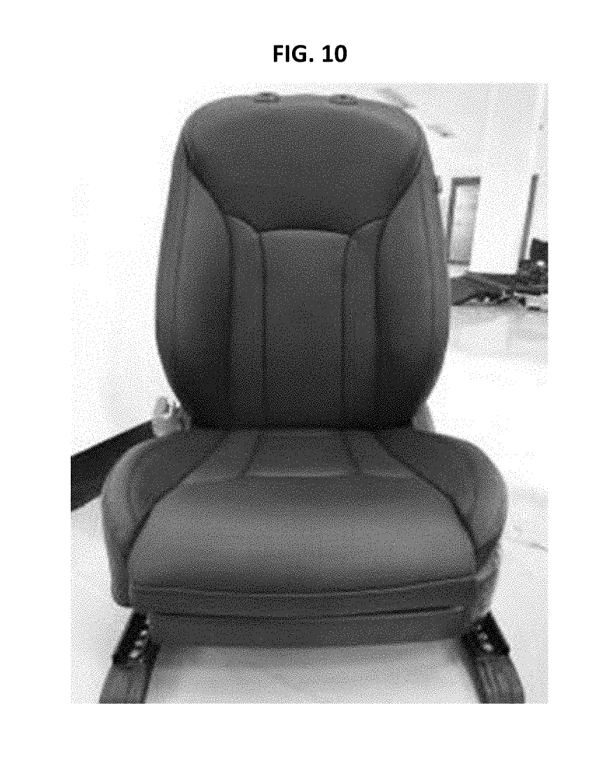

FIGS. 9 and 10 are photos showing a vehicle seat according to the related art and a vehicle seat according to the present invention.

FIG. 9 is a photo showing a vehicle seat according to the related art. Wrinkles are formed on a fabric layer of a back portion B and a cushion portion A. This means that, in the case of the vehicle seat according to the related art, a surface portion that is the fabric layer of the seat is pushed when the passenger's getting on/off is repeatedly performed. Also, when a push phenomenon occurs, due to a thick foam layer formed of a single layer, it takes a comparatively long time until the foam layer is restored to its original state so that wrinkles can be easily formed.

FIG. 10 is a photo showing a vehicle seat according to the present invention. Referring to FIG. 10, the vehicle seat according to the present invention can prevent wrinkles from being formed in spite of the passenger's repeated getting on/off. In the vehicle seat according to the present invention, the foam layer that is disposed on the bottom surface of the fabric layer 10 and serves as a cushion, is divided into the first foam layer 20 and the second foam layer 40, thereby maintaining the feeling of cushioning. Simultaneously, the backing cloth (B/CLOTH) 30 is bonded between the first foam layer 20 and the second foam layer 40 so that the first foam layer 20 and the second foam layer 40 can be moved in opposite directions within a predetermined range due to the backing cloth (B/CLOTH) 30. Thus, even when the first foam layer 20 is pushed by the passenger's getting on/off, a comparatively fast restoring force is generated so that wrinkles can be prevented from being formed on the fabric layer 10.

The vehicle seat according to the related art is manufactured using only one thick foam layer disposed on the bottom surface of the fabric layer 10 and a backing cloth disposed on a bottom surface of the foam layer. In the vehicle seat according to the related art, a problem related to formation of wrinkles of the seat occurs frequently due to the passenger's getting on/off. However, in the vehicle seat according to the present invention, the backing cloth (B/CLOTH) 30 is bonded between two foam layers, i.e., the first foam layer 20 and the second foam layer 40. Thus, when comparing FIG. 9 with FIG. 10, the effects of preventing formation of wrinkles on the surface of the seat are large. Also, densities of polyurethane foams between the first foam layer 20 and the second foam layer 40 are differently set so that the effects of riding comfort and prevention of formation of wrinkles of each portion of the seat can be attained.

Also, by bonding the backing cloth (B/CLOTH) 30 between the first foam layer 20 and the second foam layer 40, different deniers of the backing cloth (B/CLOTH) 30 and different densities of foams of the first foam layer 20 and the second foam layer 40 are applied to portions of the vehicle seat so that, even in the case of the passenger's long-term drive, a degree of fatigue can be improved and durability of the seat can be guaranteed.

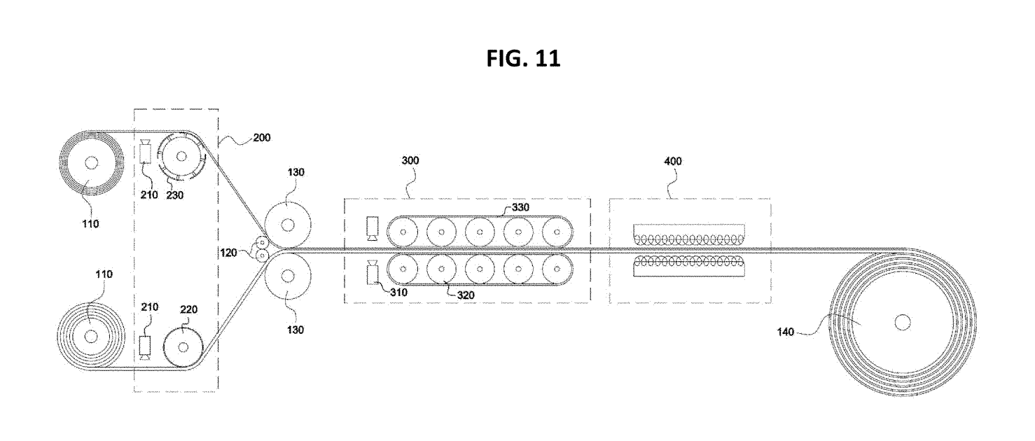

FIGS. 11 through 13 are views illustrating an embodiment of an operation of bonding two layers from among the fabric layer 10, the first foam layer 20, the backing cloth (B/CLOTH) 30, and the second foam layer 40 using a lamination method, wherein the operation of bonding is included in operations of the method of manufacturing the vehicle seat according to the present invention.

A bonding method for manufacturing the vehicle seat according to the present invention may include various methods such as bonding and lamination bonding, so as to bond respective layers. In particular, preferably, lamination bonding is used.

FIG. 11 is a cross-sectional view of lamination bonding of the method of manufacturing the vehicle seat according to an embodiment of the present invention

According to an embodiment, in lamination bonding according to the present invention, unwinding rollers 110 on which fabrics of different layers are wound, unwind the wound fabrics. Each of the unwound fabrics is corrected by a first correction unit 200 so that each fabric can be restored to its original, correct position. The fabrics, each of which position is corrected by the first correction unit 200, are bonded to each other by a support roller 120 and a guide roller 130. Subsequently, a correcting operation is performed using a second correction unit 300 before the fabrics of the two bonded layers are combined with each other, so that they are not twisted with respect to each other and can be correctly combined with each other. The fabrics of the two layers bonded in correct positions using the second correction unit 300 are combined with each other using a combining portion 400, and the combined fabrics are bonded to a winding roller 140 and are finished.

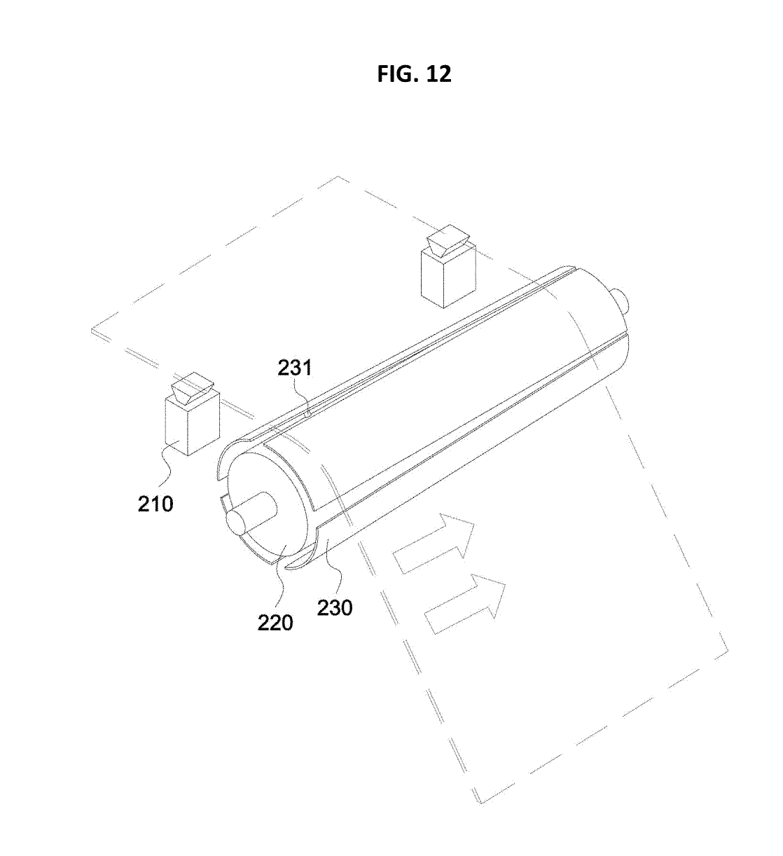

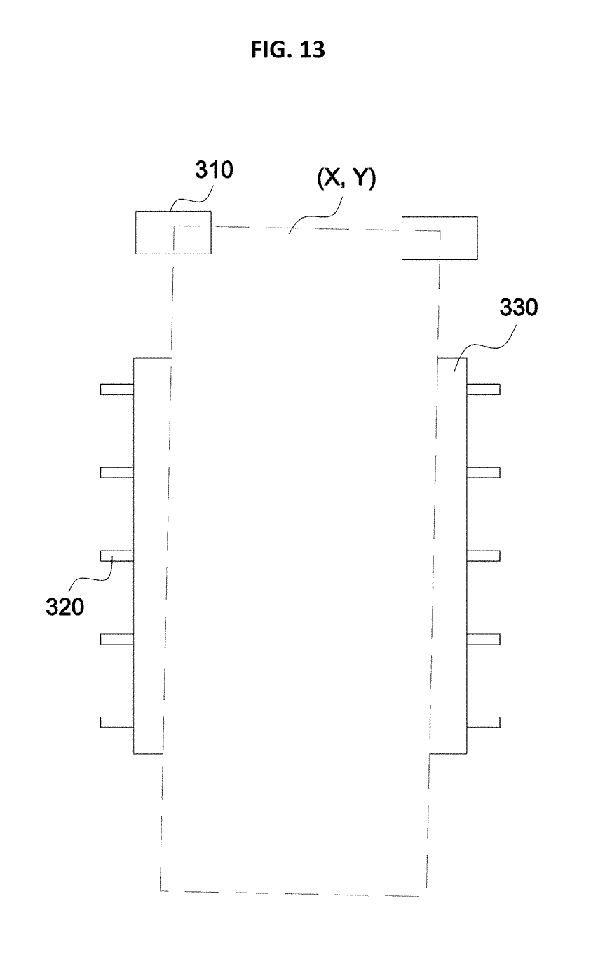

Hereinafter, the lamination bonding method will be described in detail with reference to FIGS. 12 and 13.

Referring to FIG. 12, the first correction unit 200 includes a first detecting sensor 210 and a first correction roller, and the first correction roller includes a central roller 220, a correction plate 230, and two or more diameter adjustment portions 231.

The first detecting sensor 210 that is a sensor for detecting correct supply positions of supplied fabrics X and Y, may be a camera including an infrared sensor or a light-receiving sensor. The first detecting sensor 210 detects a degree of twisted angle and direction of the supplied fabrics in a predetermined reference position of the first detecting sensor 210. Subsequently, the first correction roller is controlled according to a detected result value so as to correct supply positions of the fabrics X and Y.

The first correction roller includes a cylindrical central roller 220 in the center thereof, and a correction plate 230 disposed at a circumferential surface of the central roller 220. The central roller 220 and the correction plate 230 are connected to each other using the diameter adjustment portions 231, and the diameter of the correction plate 230 is adjusted according to heights of the diameter adjustment portions 231. The diameter adjustment portions 231 may be disposed at both sides of the correction plate 230, respectively. As the number of the diameter adjustment portions 231 provided inside the correction plate 230 is increased in a lengthwise direction of the correction plate 230, the diameter adjustment portions 231 may adjust the diameter of the correction plate 230 more precisely. Preferably, two or more correction plates 230 are provided, and more preferably, four or more correction plates 230 are provided. When the height of each of the diameter adjustment portions 231 is minimized so that the plurality of correction plates 230 are in contact with the central roller 220, preferably, the correction plates 230 contact each other and thus are bonded to each other to surround an outer circumferential surface of the central roller 220. The diameter adjustment portions 231 connected between the correction plate 230 and the central roller 220 may be individually moved. Thus, when a diameter adjustment portion 231 at one side ascends and a diameter adjustment portion 231 at the other side descends, the first correction roller may have a truncated conic shape. When the first correction roller has a truncated conic shape, the diameter adjustment portion 231 having a relatively large diameter moves the fabrics X and Y slowly, and the diameter adjustment portion 231 having a relatively small diameter moves the fabrics X and Y comparatively quickly so that the fabrics X and Y are moved from the diameter adjustment portion 231 having the relatively large diameter to the diameter adjustment portion 231 having the relatively small diameter. In the above-described manner, the first correction unit 200 may correct the fabrics X and Y so that the twisted fabrics A and B can be supplied in correction positions. The first correction roller may further include a cover portion 240 disposed outside the correction plate 230. When the correction plate 230 is widened, the first correction roller may further include the cover portion 240 formed of an elastic material so as to prevent the fabrics from being disposed between the correction plates 230.

Each of the fabrics X and Y corrected by the first correction roller is supplied in a bonding position using the support roller 120 and the guide roller 130. The fabrics X and Y of the two bonded layers undergo a correcting operation so that they can be combined in a correction position before being combined with each other. The correcting operation is performed by the second correction unit 300.

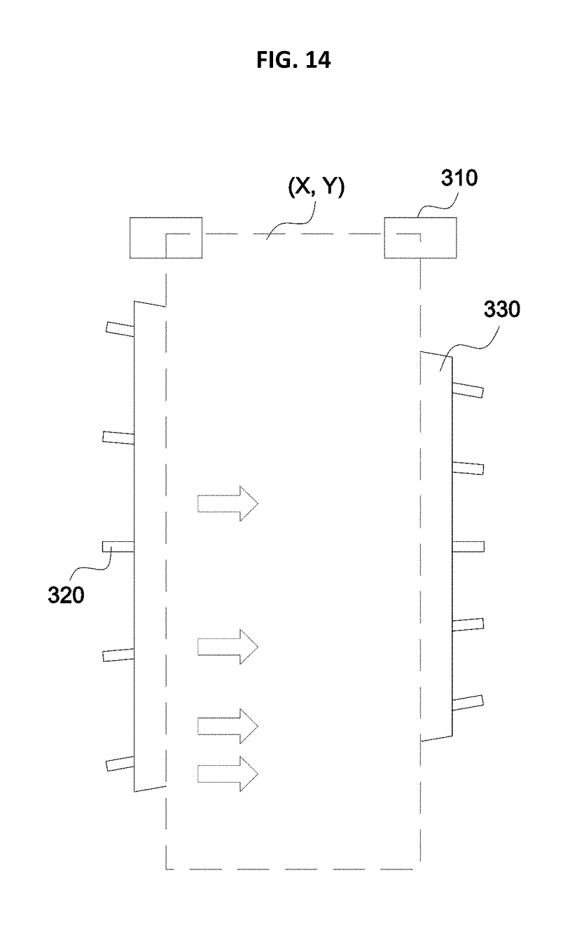

Referring to FIGS. 13 and 14, the second correction unit 300 includes a second detecting sensor 310, a plurality of trajectory rollers 320, and a plurality of trajectory belts 330.

The second detecting sensor 310 that is a sensor for detecting a correct combination position of the fabrics X and Y of the two bonded layers may be a camera including an infrared sensor or a photographing device. The second detecting sensor 310 detects a degree of twisted angle and direction of the bonded fabrics X and Y in a predetermined reference position of the second detecting sensor 310. Subsequently, the second detecting sensor 310 controls the trajectory roller 320 according to a detected result value, thereby correcting a combination position of the fabrics X and Y. In order to control a correct position of each layer, the second detecting sensors 310 may be provided at upper and lower sides of the second correction unit 300, respectively.

A pair of trajectory rollers 320, and a pair of trajectory belts 330 may be provided on top and bottom surfaces of the second correction unit 300, respectively. Preferably, a plurality of trajectory rollers 320 are provided, and preferably, the trajectory belts 330 that surround the plurality of trajectory rollers 320 are formed of a material having elasticity. The trajectory rollers 320 and the trajectory belts 330 are provided to have an infinite trajectory shape, and the plurality of trajectory rollers 320 may make a distance between the trajectory rollers 320 spaced apart from each other or close to each other, thereby adjusting the distance. However, directions of both sides of the trajectory roller 320 may be separately moved by a distance adjustment portion separately provided. Thus, a one-side direction distance and the other-side direction distance may be differently adjusted.

FIG. 13 illustrates a basic state of the second correction unit 300, and FIG. 14 illustrates a state in which the twisted fabrics X and Y are detected and a distance between the trajectory rollers 320 is adjusted. By using the second detecting sensor 310, a degree at which the fabrics X and Y deviate from their original positions, is measured, and a distance between both sides of each of the trajectory rollers 320 is separately moved. Due to the adjusted distance between the trajectory rollers 320, the fabrics X and Y are moved from the trajectory roller 320 having a relatively large distance to the trajectory roller 320 having a relatively small distance and thus are bonded to each other in place. In this case, the trajectory belts 330 that surround the trajectory rollers 320 are formed of a material having elasticity so as to be adjusted according to movement of the trajectory roller 320. Also, the trajectory rollers 320 and the trajectory belts 330 may be provided on the top and bottom surfaces of the second correction unit 300 so that the fabrics X and Y of the two layers can be corrected.

After positions of the fabrics X and Y of two layers bonded by the second correction unit 300 are corrected, a combining operation is performed using the combining portion 400. Combination may be performed using an adhesive or flame lamination. When flame lamination is used, the supplied fabrics A and B may be damaged by fired flames. Thus, the fabrics X and Y may also be bonded to each other by supplying a current to a coil to generate heat. The fabrics X and Y of which bonding is completed, are wound by the winding roller 140 and are kept.

The fabrics X and Y may be bonded by the lamination bonding method using two-layer fabrics from among the fabric layer 10, the first foam layer 20, the backing cloth (B/CLOTH) 30, and the second foam layer 40.

According to the present invention, a push phenomenon of a surface of a seat can be minimized when a passenger gets into or out of a vehicle.

In addition, due to a first foam layer, a fast restoring force is generated in the push phenomenon so that wrinkles can be prevented from being formed on a surface of the seat.

Furthermore, lifting or wrinkles of a surface can be prevented even when the seat is applied to a curved surface.

Furthermore, a thickness and a density of a second foam layer of a lower layer portion are set differently from those of a first foam layer of an upper layer portion so that, due to the first foam layer, left and right and forward and backward movements caused by getting on/off can be freely performed. In addition, because the second foam layer is closely bonded to a seat mold pad, directions of movements between the first foam layer and the second foam layer are set differently from each other so that effects of preventing formation of wrinkles can be attained.

Furthermore, a backing cloth is inserted between the first foam layer and the second foam layer so that bending wrinkles can be prevented from being formed on a curved surface or a reverse portion of a vehicle seat.

In particular, when a breathable foam is used in the first foam layer and the second foam layer of a cushion portion and a back portion, a backing cloth having breathability needs to be used. Thus, a breathable vehicle seat can also be manufactured.

Furthermore, the first foam layer has a predetermined thickness so that a feeling of cushioning and comfortableness can be maintained.

Thus, the vehicle seat can be used without being replaced with another one for a long term.

Finally, a driver's degree of fatigue for a long time can be reduced, and the passenger's riding comfort can be improved so that productivity can be increased.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A vehicle seat comprising:
a fabric layer for a vehicle seat;
a first foam layer and a second foam layer, which are disposed at a lower side of the fabric layer; and
a backing cloth disposed between the first foam layer and the second foam layer.

2. The vehicle seat of claim 1, wherein, when the vehicle seat is applied to a cushion portion or back portion, a thickness of the first foam layer is in a range between 5 and 10 mm, and a thickness of the second foam layer is in a range between 3 and 5 mm.

3. The vehicle seat of claim 1, wherein, when the vehicle seat is applied to a cushion bolster portion or back bolster portion, a thickness of the first foam layer is in a range between 3 and 5 mm, and a thickness of the second foam layer is in a range between 2 and 3 mm.

4. The vehicle seat of claim 1, wherein the backing cloth is formed of a material having flame retardance, and the first foam layer, the second foam layer, and the backing cloth are bonded to one another through double flame lamination.

5. The vehicle seat of claim 4, wherein the backing cloth comprises one fiber from among a 15 denier fiber, a 20 denier fiber, a 20 denier (zeroelongation) fiber, a 50 denier fiber, and a 150 denier fiber.

6. The vehicle seat of claim 5, further comprising an SD coating layer disposed on a bottom surface of the second foam layer.

7. The vehicle seat of claim 4, wherein the first foam layer and the backing cloth or the second foam layer and the backing cloth, which are to be bonded to each other through double flame lamination, are combined with each other using a double flame lamination bonding device,
wherein the double flame lamination bonding device comprises:
two unwinding rollers on which fabrics of different layers are wound;
a first correction unit configured to detect a correct position of each of the unwound fabrics and to correct the fabrics;
a support roller and a guide roller, which are configured to adjust directions of the fabrics so that the fabrics are bonded to each other;
a second correction unit configured to correct positions of the fabrics so that the fabrics of the two bonded layers are precisely combined with each other; and
a combining portion configured to combine the fabrics of the two bonded layers in a correct position using the second correction unit,
wherein the first correction unit comprises a first detecting sensor and a first correction roller, the first correction roller comprising a central roller, a correction plate, and two or more diameter adjustment portions configured to connect the central roller and the correction plate and to adjust a diameter of the correction plate, and
wherein the second correction unit comprises a second detecting sensor, a plurality of trajectory rollers, and a plurality of trajectory belts, the plurality of trajectory rollers and the plurality of trajectory belts being provided to have an infinite trajectory shape, and the plurality of trajectory rollers capable of adjusting a distance between the trajectory rollers.

8. A method of manufacturing a vehicle seat, comprising:
performing SD coating on a bottom surface of a second foam layer;
performing primary bonding of the second foam layer and a backing cloth using a flame lamination method;
performing secondary bonding of the backing cloth bonded to the second foam layer and a first foam layer using a flame lamination method; and
bonding a fabric layer onto a top surface of the first foam layer.
